(19) United States
(12) Patent Application Publication
(10) Pub. No.: US 2010/0332969 A1
(43) Pub. Date: Dec. 30, 2010

(54) Dynamic Use of Device Theme Parameters for Rendering Markup Content

(76) Inventors: Ramprabhu Jayaraman, Highland Park, NJ (US); Nedim Fresko, Redwood City, CA (US); Timothy Neil, Mississauga (CA); Rowell Cruz, Mississauga (CA)

Correspondence Address: Eckert Seamans Cherin & Mellott, LLC, 600 Grant Street, 44th Floor, Pittsburgh, PA, 15219, US

(21) Appl. No.: 12/493,339

(22) Filed: Jun. 29, 2009

(51) Int. Cl. G06F 17/00

(52) U.S. Cl. 715/234

(57) ABSTRACT

An improved method enables markup content on an electronic device, such as a web page or other markup content, that includes its own rendering parameters to be rendered on the electronic device according to the theme rendering parameters of the device rather than the rendering parameters included on the web page.

### CROSS-REFERENCE TO RELATED APPLICATION

The instant application claims priority from U.S. Provisional Patent Application Ser. No. 61/106,589 filed Oct. 19, 2008, the disclosures of which are incorporated herein by reference.

### BACKGROUND

1. Field

The disclosed concept relates generally to the rendering of content on an electronic device, and more particularly, refers to the dynamic usage of theme rendering parameters on an electronic device to render markup content that otherwise has its own rendering parameters.

2. Description of the Related Art

It is known that web application developers create web applications that are executed on servers and that include web content which is made available to clients via a network such as the worldwide web. The web application typically is deployed to a server, and the web content typically is stored in the form of web pages and other content that are made available to the application. Such web pages often include instructions in a markup language such as html, and the instructions are generally in the nature of instructions for a client, such as an instruction as to how certain content should be rendered on a display of the client device.

Certain content on an electronic device, such as web content in the form of web pages that are downloaded as data files to the electronic device via a network such as the worldwide web, may be rendered on a display of the electronic device in accordance with one or more rendering parameters that are provided with the content. For instance, a web page that is downloaded to an electronic device such as a desktop computer, a mobile electronic device, and the like, may include as part of the markup contents one or more rendering parameters that together make up a cascading style sheet (CSS). A CSS may contain parameters that indicate to a rendering engine on the electronic device certain parameters that the rendering engine is to employ when rendering the markup content such as a background color of the web page, a border color of the web page, and the like. Markup content can likewise exist on an electronic device without being received via the worldwide web, such as when a person creates html on the electronic device or when applications on the device generate html or other markup content that is to be rendered on the electronic device. The CSS of a web page is a part of the web page, and its parameters typically apply to all of the content of the page for the purpose of rendering the content on the electronic device. It is also known that in the absence of a CSS, html to be rendered will be rendered according to one or more default rendering parameters, such as of a browser.

It is further known to provide a feature on an electronic device whereby a theme can be selected for use in rendering certain content on the device. For instance, the selectable theme parameters can include a particular background color, a particular border color, and other parameters that are used as default rendering parameters for content that is rendered on the electronic device. As a general matter, when an application is executed on the electronic device, any rendering that is required by the application will be rendered in accordance with the theme properties of the device. However, when content such as the aforementioned web page or other markup includes its own rendering parameters, such as the aforementioned parameters in a CSS of the web page, or in the absence of a CSS wherein html is rendered according to one or more default rendering parameters of a browser, for example, those rendering parameters are used in rendering of the content of the web page rather than employing the theme parameters of the electronic device. As such, the theme parameters on an electronic device typically are used for only a portion of the rendering operations on an electronic device since markup content that possesses its own rendering parameters is rendered using those parameters, rather than the theme rendering parameters of the electronic device. By way of example, portions of a browser man themselves be rendered using the theme rendering parameters of the device while the markup content that is being rendered by the browser may itself be rendered using different colors. It thus would be desirable to provide an improved system wherein the inconsistent rendering of subject matter on a display of an electronic device is avoided.

### BRIEF DESCRIPTION OF THE DRAWINGS

A full understanding of the disclosed concept can be obtained from the following Description when read in conjunction with the accompanying drawings in which:

FIG. 1 is a schematic depiction of an electronic device in accordance with the disclosed concept on which can be performed the improved method of the disclosed concept;

FIG. 2 is a schematic operational diagram in accordance with an embodiment of the disclosed concept;

FIG. 3 is a schematic operational diagram in accordance with another embodiment of the disclosed concept;

FIG. 4 is a flowchart depicting certain aspects of an embodiment of an improved method that can be performed with the operational diagram of FIG. 2; and

FIG. 5 is a flowchart depicting certain aspects of another embodiment of the improved method that can be performed with the operational diagram of FIG. 3.

Similar numerals refer to similar parts throughout the specification.

### DESCRIPTION

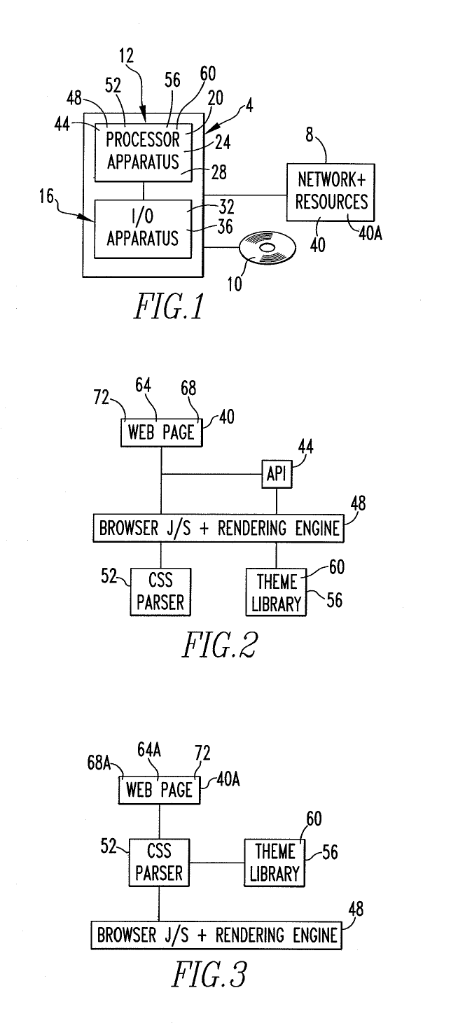

An improved electronic device is depicted in FIG. 1 and is indicated generally at the numeral 4. The electronic device 4 can be any of a wide variety of devices such as mobile electronic devices, desktop computers, and the like without limitation. The electronic device 4 is depicted as being connected with a network and a number of resources that are indicated generally at the numeral 8. The network and resources 8 in the depicted example may include, for instance and without limitation, the worldwide web and servers with web content, respectively, but the concepts presented herein are intended to be broadly applicable to any situation wherein markup content of one kind or other is to be processed on the electronic device 4. While such processing on the electronic device 4 is described herein in an exemplary fashion as being related to rendering, it is understood that the concepts herein are applicable to processing other than or additional to rendering processing. While the electronic device 4 and the network and resources 8 are depicted in FIG. 1 as having a wired connection therebetween, it is understood that other types of connections, including wireless connections, can exist between the electronic device 4 and the network and resources 8 without departing from the present concept. It is also noted that the electronic device can render html or other markup in the absence of the network and resources 8, and that the concepts described herein are equally applicable to such a situation.

Also depicted in FIG. 1 is a CD ROM 10 that is capable of interfacing with the electronic device 4. The CD ROM 10 is a machine readable storage medium having instructions stored thereon that are receivable on the electronic device 4 and that, when processed thereon, cause the electronic device 4 to perform at least some of the operations described herein. It is understood that the CD ROM 10 is intended to be merely an example of one way in which instructions can be received on the electronic device 4. It is understood that the instructions stored on the exemplary CD ROM 10 can be received on the electronic device 4 in other fashions, such as through the network and resources 8 or otherwise without limitation.

The schematically represented electronic device 4 includes a processor apparatus 12 and an input/output apparatus 16 in operative connection. The processor apparatus 12 includes a processor 20 such as a microprocessor or other processor, a memory 24 that interfaces with the processor 20, and a number of routines 28 that are stored in the memory 24 and are executable on the processor 20. The broadly-characterized routines 28 would include, for instance, all of the instructions on the device platform and would include, for instance, an operating system and other applications such as a browser routine 28 that interface with the operating system. The memory 24 thus can also be said to be a machine readable storage medium. In the exemplary embodiment presented herein, the operating system creates a Java runtime within which the browser routine 28 is executed, although the concepts presented herein can be employed in other processing environments without departing from the present concept.

The input/output apparatus 16 is configured to provide input signals to the processor 20 and to receive output signals therefrom and can be said to include, for example, a display 32 and a keyboard 36 among other input and output components such as speakers, pointing devices, and other devices without limitation. It is understood that the input/output apparatus 16 could additionally or alternatively comprise a touch sensitive display.

The disclosed concept advantageously enables markup content, which may come with its own rendering parameters, to be rendered on the electronic device 4 according to one or more theme rendering parameters stored on the electronic device 4 rather than being rendered according to the rendering parameters received with the content or the default rendering parameters. In accordance with a first embodiment of the disclosed concept, this improved functionality is provided, at least in part, by an application programming interface (API) 44 that is depicted in a schematic fashion in FIG. 2 and that is executable on the processor 20. The API 44 is depicted in a schematic fashion as interfacing between markup content on the electronic device 4 which is depicted as being an exemplary web page 40 and a browser JavaScript and rendering engine 48. The browser JavaScript and rendering engine 48 is depicted in FIG. 2 as interfacing with a cascading style sheet (CSS) parser 52 and a theme library 56. The browser JavaScript and rendering engine 48 and the CSS parser 52 can generally be said to be components of a browser routine 28 that is executable in the Java runtime afforded by the operating system of the electronic device 4. The theme library 52 typically is part of the operating system of the electronic device 4 rather than being part of the browser routine 28, but this need not necessarily be the case in all situations.

The theme library 56 is a repository wherein one or more device rendering parameters 60 may be stored. By way of example, the operating system of the electronic device 4 may provide a plurality of selectable themes that, for instance, specify one or more rendering parameters, for example, that will be used by the routines 28 in rendering output on the display 32. A selectable theme might, for instance, specify a particular background color, a particular border color, a particular text color, etc., by way of example and without limitation. As a general matter, when an application that is being executed in the runtime afforded on the electronic device 4 by the operating system generates content that is to be rendered on the display 32, such rendering is done in accordance with the device rendering parameters 60 stored in the theme library 56.

The exemplary web page 40 on the electronic device 4 is depicted in FIG. 2 as comprising markup subject matter that is to be rendered on the display 32 using the rendering engine portion of the browser JavaScript and rendering engine 48. The web page 40 comprises a cascading style sheet (CSS) 64 that comprises one or more CSS rendering parameters 68. As is generally understood, the CSS rendering parameters 68 would ordinarily have been specified by the creator of the web page 40 for use by a rendering engine when rendering the content of the web page 40. That is, the CSS rendering parameters 68 are in the nature of rendering parameters that are included in the data file of the web page 40 and that specify the fashion in which the subject matter of the web page 40 is to be rendered on a display. The CSS rendering parameters 68 thus may also be referred to as file rendering parameters.

However, the web page 40 depicted in FIG. 2 additionally includes a number of instructions written in a scripting language, such as a number of special JavaScript instructions 72 by way of example. The JavaScript instructions 72 of the web page 40 will likely have been written for inclusion in the web page 40 itself by the creator of the web page 40, but it is understood that the JavaScript instructions 72 potentially could be added to the web page 40 in other fashions without limitation.

The browser JavaScript and rendering engine 48 receives the JavaScript instructions 72 from the web page 40 and executes them. The JavaScript instructions 72 may be in the nature of calls to the API 44 to cause the API 44 to obtain from the theme library 56 one or more of the device rendering parameters 60 stored therein. As such, the JavaScript instructions 72 may be something other than in JavaScript without departing from the disclosed concept. The JavaScript instructions 72 may, for instance, look something like the following:

var theme=window.getThemeBuilder( ):

var background=theme.getBackgroundColor( ):

element.setAttribute(“background-color”,background.

By way of example, “getThemeBuilder” may be the name of the JavaScript object in the API 44 that includes the list of names of the various subroutines that can be called by the API 44. By way of further example, “getBackgroundColor” may be the name of one of the subroutines which, when executed, returns from the theme library 56 the value of the device rendering parameter 60 which specifies the theme background color, and the variable “background” will be given this value.

At some point, the CSS parser 52 will parse the CSS to obtain the CSS rendering parameters 68 and will place them in temporary storage. The API 44 thereafter will revise the way in which the CSS rendering parameter 68 “background-color” will be represented internally within the electronic device 4. For instance, the CSS rendering parameter 68 “background-color” stored in temporary storage may be reset to the value of the variable “background”, i.e., the value of the theme background color device rendering parameter 60 that was returned to the API 44 from the theme library 56. Other ways of changing the internal representation of a parsed CSS rendering parameter 68 can be envisioned, and the example presented herein is not intended to be limiting.

It thus can be understood that the system depicted schematically in FIG. 2 employs the special JavaScript instructions 72 to trigger the API 44 to obtain from the theme library 56 the device rendering parameters 60 and to revise the way in which the parsed CSS rendering parameters 68 are internally represented, i.e., they are internally represented as being the retrieved device rendering parameters 60. Thereafter, the browser JavaScript and rendering engine 48 will employ the revised representation of the CSS rendering parameters 68, i.e., the device rendering parameters 60. Thus, when the browser JavaScript and rendering engine 48 renders the content of the web page 40 it will be rendered in a fashion that corresponds with the theme of the electronic device 4.

The API 44 also enables the revised internal representation of the CSS rendering parameters 68 to be further revised in the event that the theme library 56 changes. This occurs by the web page 40, and more specifically the JavaScript instructions 72 thereof, registering with the browser JavaScript and rendering engine 48 to cause the API 44 to be informed if any of the device rendering parameters 60 in the theme library 56 are changed. In such an event, the browser routine 28 would detect a change in the theme library 56 and would push to the API 44 the updated device rendering parameters 60. The API 44 would then further revise the internal representation of the CSS rendering parameters 68 in temporary storage, as appropriate, to reflect the new theme stored in the theme library 56.

A second embodiment of the disclosed concept is depicted generally in FIG. 3. In the second embodiment, another web page 40A includes a CSS 64A having a number of CSS rendering parameters 68A that are of a fundamentally different nature than the CSS rendering parameters 68 of the CSS 64. Specifically, the CSS rendering parameters 68A are more in the nature of variables than static parameters. For instance, instead of having as a parameter of the background color a fixed value such as “white”, the CSS rendering parameter 68A for the background color might be something like “use theme background color”. When the CSS parser 52 reads this particular CSS rendering parameter 68A, the CSS parser 52 will interface directly with the theme library 56 to obtain the device rendering parameter 60 indicative of the theme background color, and the CSS parser 52 will employ this value when providing CSS parameter data to the browser JavaScript and rendering engine 48. That is, the CSS rendering parameter 68A will be interpreted by the CSS parser 52 as being a variable that is in need of having a value assigned thereto, and the CSS parser 52 will obtain the needed value from the theme library 56. When the CSS parser 52 sends to the browser JavaScript and rendering engine 48 the CSS rendering parameters 68A, it will be sending variables having as their values the device rendering parameters 60 retrieved from the theme library 56 by the CSS parser.

It thus can be seen that the disclosed concept involves two fashions in which theme data of the electronic device 4 can be employed to render the content of a web page 40 or 40A. In the example of FIG. 2, the API 44 causes the internal representation of the CSS rendering parameters 68 of the web page 40 to be revised to reflect the device rendering parameters 60 of the theme library 56. In the embodiment of FIG. 3, the CSS rendering parameters 68A are in the form of variables, and the CSS parser 52 sets these variables to the values of the device rendering parameters 60 that it retrieves from the theme library 56.

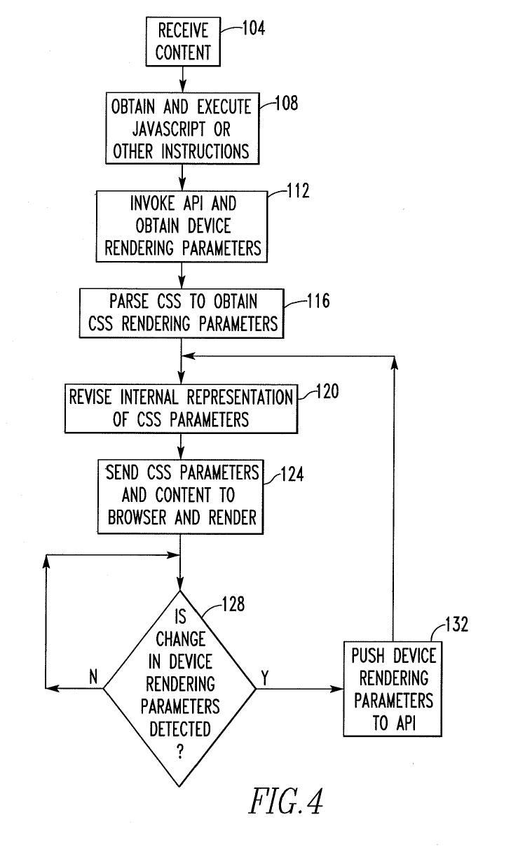

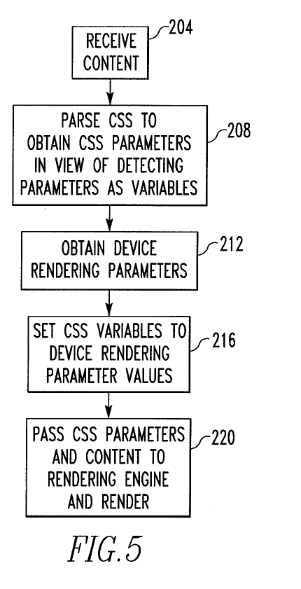

FIG. 4 depicts with a flowchart some of the aspects of an improved method of the embodiment in FIG. 2. Processing begins, as at 104, where the content is, for instance, received on the electronic device 4 in the form of the web page 40, or markup content that is already present on the electronic device 4 is received by the browser JavaScript and rendering engine 48 for rendering. The browser JavaScript and rendering engine 48 then obtains, as at 108, the JavaScript instructions 72 from the web page 40 and executes them. The executed JavaScript instructions 72 cause the API 44 to be invoked, as at 112, and to cause it obtain from the theme library 56 the device rendering parameters 60. The CSS parser 52 parses, as at 116, the CSS 64 and obtains from it the CSS rendering parameters 68. The JavaScript instructions 72 then cause, as at 120, the internal representation of the CSS rendering parameters 68 to be revised, i.e., updated, to reflect the retrieved device rendering parameters 60. Again, it is understood that the specific implementation described herein is merely intended to be a non-limiting example.

The CSS parser 52 passes, as at 124, the revised internal representation of the CSS rendering parameters 68 and the content of the web page 40 to the browser JavaScript and rendering engine 48 which renders the content on the display 32 in accordance with the revised CSS rendering parameters 68.

It is determined, as at 128, whether any change in the device rendering parameters 60 has occurred. If not, processing continuously loops back to 128 until it is determined that a change has, in fact, occurred to the device rendering parameters 60. Processing will thereafter continue, as at 132, where the updated device rendering parameters 60 are pushed to the API 44. Processing thereafter continues, as at 120, where the updated device rendering parameters 60 are employed to further revise the internal representation of the CSS rendering parameters 68. It is understood that the loop indicated generally at the numeral 128 can be represented and implemented in numerous fashions on the electronic device 4.

FIG. 5 generally depicts in a flowchart certain aspects of an improved method of the embodiment in FIG. 3. Processing begins, as at 204, where content is received on the electronic device 4 in the exemplary form of the web page 40A, or content already on the electronic device 4 is received for processing by the browser JavaScript and rendering engine 48. The CSS parser 52 then parses, as at 208, the CSS 64A and obtains the CSS rendering parameters 68A which are in the form of variables. The CSS parser 52 then obtains, as at 212, the device rendering parameters 60 from the theme library 52. The CSS parser 52 then sets, as at 216, the variables of the CSS rendering parameters 68A to the values of the device rendering parameters 60 that were obtained at 212. Processing thereafter continues, as at 220, where the CSS parser 52 passes to the browser JavaScript and rendering engine 48 the CSS rendering parameters 68A in the form of variables set to the values of the obtained device rendering parameters 60. It is understood that the variable values of the CSS rendering parameters 68A can be further updated by the CSS parser 52 in the event that the device rendering parameters 60 are changed.

It thus can be seen that the disclosed concept enables markup content on the electronic device 4 that has its own rendering parameters or that uses default rendering parameters to be instead rendered on the electronic device 4 using the device rendering parameters 60 stored in the theme library 56. This can be achieved in any of a variety of fashions, two exemplary fashions of which are depicted in FIGS. 2-5.

While specific embodiments of the disclosed concept have been described in detail, it will be appreciated by those skilled in the art that various modifications and alternatives to those details can be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method on an electronic device that has a number of device rendering parameters of enabling at least some of the content of a markup data file that otherwise would be rendered according to a number of file rendering parameters to be rendered in a fashion that employs the device rendering parameters, the method comprising:
obtaining at least some of the device rendering parameters;
revising the way in which at least one of the file rendering parameters is internally represented on the electronic device by causing it to be represented as being at least one of the device rendering parameters; and
rendering on the electronic device at least some of the content of the data file on the electronic device using the revised file rendering parameters.

2. The method of claim 1, further comprising executing a number of instructions in the data file and, responsive thereto, initiating the obtaining, revising, and rendering.

3. The method of claim 1, further comprising detecting a change in at least one device rendering parameter and, responsive thereto, further revising the internal representation of at least one of the file rendering parameters to be represented as being the at least one device rendering parameter, and rendering on the electronic device at least some of the content of the data file on the electronic device using the further revised file rendering parameters.

4. A method on an electronic device that has a number of device rendering parameters of enabling at least some of the content of a markup data file that would otherwise be rendered in accordance with a number of file rendering parameters to be rendered in a fashion that employs the device rendering parameters, the method comprising:
obtaining from the data file a number of the file rendering parameters;
detecting at least a first file rendering parameter of the number of file rendering parameters as being an instruction to employ as the at least first file rendering parameter at least a first device rendering parameter;
employing the at least first device rendering parameter as being the at least first file rendering parameter to render at least some of the content of the data file on the electronic device.

5. An electronic device comprising:
a processor apparatus comprising a processor and a memory;
an input/output apparatus structured to provide input signals to the processor apparatus and to receive output signals therefrom;
the memory having stored therein a number of routines that comprise a number of instructions which, when executed on the processor, cause the electronic device to perform operations comprising:
obtaining at least some of the device rendering parameters;
revising the way in which at least one of the file rendering parameters is internally represented on the electronic device by causing it to be represented as being at least one of the device rendering parameters; and
rendering on the electronic device at least some of the content of the data file on the electronic device using the revised file rendering parameters.

6. The electronic device of claim 5 wherein the operations further comprise executing a number of instructions in the data file and, responsive thereto, initiating the obtaining, revising, and rendering.

7. The electronic device of claim 5 wherein the operations further comprise detecting a change in at least one device rendering parameter and, responsive thereto, further revising the internal representation of at least one of the file rendering parameters to be represented as being the at least one device rendering parameter, and rendering on the electronic device at least some of the content of the data file on the electronic device using the further revised file rendering parameters.
